(19) United States
(12) Patent Application Publication
(10) Pub. No.: US 2004/0157549 A1
(43) Pub. Date: Aug. 12, 2004

(54) Method for routing data in a mobile communication network and communications network device for carrying out such a method

(76) Inventors: Joachim Dold, Berlin (DE); Lutz Jarbot, Berlin (DE); Gerald Lehmann, Berlin (DE); Axel Meiling, Berlin (DE)

Correspondence Address: STAAS & HALSEY LLP, SUITE 700, 1201 NEW YORK AVENUE, N.W., WASHINGTON, DC, 20005, US

(21) Appl. No.: 10/474,750

(22) PCT Filed: Apr. 11, 2002
(86) PCT No.: PCT/EP02/04059

(30) Foreign Application Priority Data
Apr. 11, 2001 (DE) 101 18 188.4

(51) Int. Cl. H04B 7/15

(52) U.S. Cl. 455/7; 455/11.1

(57) ABSTRACT

The invention relates to a method for routing data (d) in a mobile communications network with non-stationary relay stations (MS2), according to which data (d) is transmitted from a first station (MS1) to a target station (MS3) via a route (V12-V23), and, in the case that is not possible to conduct a direct transmission from the first station (MS1) to the target station (MS3), the data is received and relayed by the relay station (MS2) during the transmission on the route. The determination of the route (V12-V23) should preferably be carried out or updated in the first station (MS1) and/or in relay stations (MS2). The determination of the route (V12-V23) can be carried out, in particular, by using cards with routes, population information and/or topographical information. The determination of the route (V12-V23) can also or alternatively be carried out by using search programs for, in particular, statistically and/or iteratively ascertaining an optimized route.

The invention relates to a method for routing data in a mobile communication network with the characteristics in the description of claim 1 and a communication network device for carrying out such a method.

For current communication networks with mobile subscribers, the actual network consists of one or more stationary network or base stations that build up a radio cell within an area around themselves. Subscriber stations within this radio cell can communicate via the radio interface with the network station that for its part can forward the connection to other network equipment.

For the future, mobile radio systems are discussed in which the communication network features mobile terminals or stations instead of stationary network stations. This means that stationary base stations are no longer needed because information and data are directly relayed from terminal to terminal. Jumps for routing data via several subscribers not directly involved in the communication process are provided. Therefore, the network varies in time and needs a minimum number of stations lying in between serving as relay stations for transmitting the data between two remote stations. In the most extreme case, the transmitting station, the relay station(s) and the receiving station are all mobile stations that are found, for example, in vehicles and move with those. However, for such mobile networks the problem of routing data or information via several non-stationary stations exists.

Initially discussed routing strategies provide for routing tables into which the best routes are entered. However, such methods are disadvantageous because these tables would have to be made available for each station which would require a large increase in signaling and would considerably reduce the efficiency of the entire system. The network also changes very quickly in the case of stations that move very quickly so that the tables would constantly have to be adapted to the new conditions which would also limit the capacities of the stations. Further routing algorithms that have been discussed, in particular, assume that certain stations are at least stationary network stations and can, therefore, not be used.

The object of the invention is to propose an alternative method for routing data or information in mobile networks via a number of non-stationary stations.

This object of the invention is achieved by means of a method for routing data in a mobile communication network with the characteristics of claim 1 or by means of communication network devices for carrying out such a method with the characteristics of claim 10.

The method for routing data in a communication network with non-stationary relay stations, according to which data is transmitted from a first station to a destination station via a route and, if it is impossible to transmit the data directly from the first station to the destination station, the data is received and relayed by the relay station during the transmission on the route. It is particularly advantageous if the route is determined or updated in the first station and/or in relay stations.

A communication network station for carrying out such a method is equipped with a processor for processing the information via the destination station and/or relay stations and from routing information, with a memory for storing route-relevant information, a transmitting and receiving device for transmitting and receiving data to be transmitted and a position-determining device for determining the current position of the station and is at the same time advantageously designed both constructively and functionally as a transmitting, relay and destination station. The dependent claims relate to advantageous further developments of the invention.

Determining the alternate route by using maps with routes, population density information and/or topographical information makes it possible to determine a mobile route with due consideration to routes and relay stations which can be favored. The route can also or alternatively be determined by using search programs for, in particular, the statistical and/or iterative establishment of an optimized route and is advantageous when such data is missing or to supplement it.

According to this invention, the data can be transmitted advantageously as package data from station to station or continuously via the route after a continuous connection has been set up.

The stations and/or relay stations, in particular, the transmitting stations know their current location in an appropriate way so that they themselves can optimize route planning. This possibility is supported by determining the route in the first station and/or in the relay stations by means of a route planning system and/or an autonavigation system and/or traffic density data.

In the stations that determine the route, the relay stations can also adapt to the changing route conditions by using information about at least the neighboring stations, their current and/or planned movement directions, transmission capacities and/or expected ends of the switch-on times.

Superimposing or adding route data via a preferred or specific route to the data, allows, on the one hand, the specifying of routes so that it need not be determined anew in each relay station. Superimposing or adding an expiry date reduces unnecessary network loads for roaming data in the case of which neither the sender nor the destination station can be reached because of, for example, changed route conditions.

Storing information in route data and/or stations via recovered data transmitted at intervals or directly, and/or regional and/or routes prioritized in time has the advantage that dead end type routes are not used at all or at least not repeatedly or that particularly safe routes can be selected for the transmission.

An exemplary embodiment is explained in greater detail below based on the drawing.

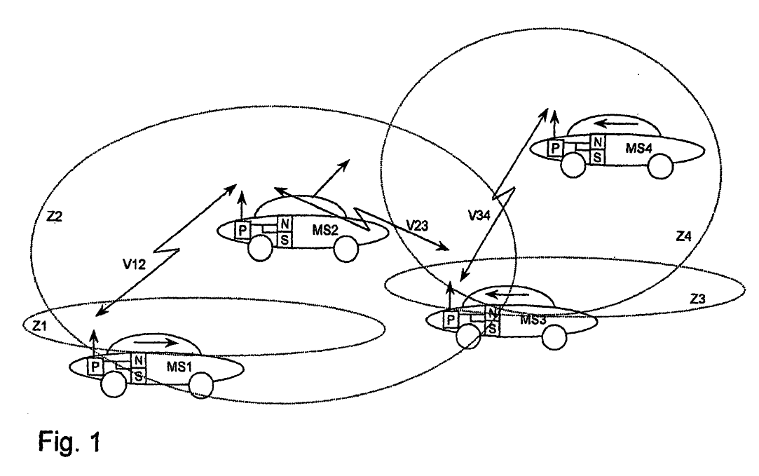

FIG. 1 shows a diagram of a mobile network with several mobile stations by means of which data is transmitted.

As can be seen in FIG. 1, a mobile or open network consists of many stations MSi (i=1, 2, 3, . . . ) that communicate with one another. Each one of the stations MSi then forms its own radio cell Zi (i=1, 2, 3, . . . ) around it. Connections between the stations MSi and MSj can be set up via a radio interface Vij (i=1, 2, 3, . . . ; j=1, 2, 3, . . . ) if a first station MS1 is found in the radio cell Z2 of a second station MS2.

Naturally, it is not compulsory for all the individual stations to be mobile, but can also be operated as stationary stations. Data can also be exchanged in the existing manner via the individual interfaces that, for example, because of local data such as larger impassable or passable ranges, have not been embodied as a radio interface but as, for example, a wired interface between two stationary stations, provided that these stationary stations can communicate with the mobile stations according to the relevant standards.

Should data, particularly data packages d be transmitted from a first station MS1 to a remote third station MS3 whose radio cells Z1 or Z3 do not reach the other station MS3 or MS1 in each case, the data d can also be transmitted via relay stations. In this example, the first station MS1 is in the range of the radio cell Z2, and can therefore set up a radio interface V12 and communicate via it with this second station MS2.

As a result, the second station MS2 in whose radio cell Z2 the third station MS3 is also found, sets up a radio interface V23 provided that this has not already been set up.

The data d is then transmitted from the first station MS1 to the third station MS3 by interconnecting the second station MS2 as a relay station via the radio interfaces V12 and V23. Alternatively, the data can then be transmitted at intervals as block from station to station but also directly via both radio interfaces V12 and V23 after a continuous connection has been set up. In the latter case, even a continuous transmission in two directions is possible in extreme cases.

In order to transmit an information or data package correctly, the following conditions should preferably be fulfilled. Stations MS1 MS3 involved in the transmission, but at least the transmitting and final receiving stations MS1 or MS3 should know their current location. For this, stations MSi preferably have a route planning system with GPS connection (GPS: global positioning system). Should a mobile station MSi be used in a motor vehicle, the central computer device P can then be connected to an autonavigation system N used in the motor vehicle in an advantageous way.

In addition, information about the current or neighboring stations MSi should be available in the foreseeable future in all the stations MSi or should be obtainable for these by means of, for example, paging on a search channel. Such information, for example, can be data about the location, current and/or planned routes/direction of movement, transmission capacity or expected ends of the switch-on time. In the most preferred embodiment, the transmitting station or the station MS1 requesting a connection also recognizes the data, particularly the position of the receiving or called destination station MS3.

When data d has to be transmitted, particularly the transmitting station MS1 determines the shortest route for the required data connections. In a first approach, this is the shortest route. For this route, the data is superimposed, for example, in a header, whereupon the data d or the data package is transmitted from the transmitting station MS1. In this example, transmission takes place from the first station MS1 via the first interface V12 to the second station MS2. From the second station MS2 that serves as a relay station, this data d is then relayed via the second interface V23 to the third station MS3 that is also at the same time the destination station here. In the case of further remote stations MS4, relaying can also take place here via many relay stations until the data d arrives at its destination.

If a relay station determines that relaying along the original best route, for example, by means of a change of direction of station MS3 or, for example, for capacity reasons is not practical, this relay station MS2 can calculate a new ideal route and use it in the header instead of the previous data in a preferred embodiment. Alternative routes can also be superimposed.

Therefore, data d can also be rerouted if required so that a retransmission or even a total loss can be avoided. In order to avoid overloading the network with “aimless” relayed data in the case of which neither the receiver nor the sender can be determined, an expiry date can also be superimposed when this data d will expire or be deleted.

It is, in particular, also practical to relay data d in directions that do not correspond to the shortest possible route, but therefore is a safe route. As a result, it can be avoided that the data d is transmitted through a region in which stations MSi are only found very seldom or with insufficient cover. Therefore, “dead ends” that would implicate a retransmission or losses by means of relay stations that are suddenly cut off in all directions can be avoided.

Preferred routes can be planned and prioritized by means of densely populated areas or along routes with much traffic.

In order to avoid repeated relaying of data d into dead ends, corresponding information about recovered data transmitted at intervals or directly can be stored in the stations MSi. As memory, a memory S can be used in station MSi in which the required system data is also logged. Alternatively or additionally, corresponding information about routes stored in vain can also be superimposed for data d itself.

In the case of specific route planning, for example, along routes with much traffic, the routes can also be classified with regard to the average or time-dependent traffic density in a route planner that need not necessarily be a road traffic planner. This information can then be taken into consideration when planning or replanning a route. In the ideal case, even currently determined traffic density values of the region can be used for the planning.

1. Method for routing data in a communication network with non-stationary relay stations (MS2, MS3), according to which
data is transmitted from a first station (MS1) to a destination station (MS3, MS4) via a route,
if it is impossible to transmit the data directly from the first station (MS1) to the destination station (MS3, MS4), the data is received and relayed by at least one relay station (MS2, MS2, MS3) during the transmission on the route, characterized in that
the route is determined or updated in the first station (MS1) and/or in at least one relay station (MS2, MS2, MS3).

2. Method according to claim 1, according to which
the route can be determined by using maps with routes, population information and/or topographical information.

3. Method according to claim 1 or 2, according to which
the route can also or alternatively be determined by using search programs for, in particular, the statistical and/or iterative establishment of an optimized route.

4. Method according to an above-mentioned claim, according to which
the data can be transmitted as package data from station (MS1, MS2, MS3) to station (MS2, MS3, MS4) or continuously via the route after a continuous connection has been set up.

5. Method according to an above-mentioned claim, according to which
the first station (MS1) and/or the destination station (MS3, MS4) and/or at least one relay station (MS2, MS2, MS3) knows its current location.

6. Method according to an above-mentioned claim, according to which
the route is determined in the first station (MS1) and/or in at least one relay station (MS2, MS2, MS3) by means of a route planning system and/or an autonavigation system (N) and/or traffic density data.

7. Method according to an above-mentioned claim, according to which
information about at least the neighboring stations (MS1, MS2, MS3) their current and/or planned movement directions, transmission capacities and/or expected ends of the switch-on times is used in the station or stations (MS1, MS2, MS3) that determine the route.

8. Method according to an above-mentioned claim, according to which
route data is superimposed or added via a preferred or specific route and/or an expiry date to the data.

9. Method according to an above-mentioned claim, according to which
information about recovered data transmitted at intervals or directly, and/or regional and/or routes prioritized in time, can be stored in route data and/or stations (MS1, MS2, MS3, MS4).

10. Communication network station (MS1, MS2, MS3, MS4) for carrying out a method according to an above-mentioned claim, with
a processor for processing information about the destination station (MS3, MS4) and/or relay stations (MS2, MS2, MS3) and route information,
a memory (S) for storing route-relevant information,
a transmitting and receiving device for transmitting and receiving data to be transmitted,
a position determining device (P) for determining the current position of the station (MS1, MS2, MS3, MS4).
